(19) United States
(12) Patent Application Publication
(10) Pub. No.: US 2023/0296256 A1
(43) Pub. Date: Sep. 21, 2023

(54) WAX MELTING POT

(71) Applicant: Michael Misiolek, Hopewell, NJ (US)

(72) Inventor: Michael Misiolek, Hopewell, NJ (US)

(21) Appl. No.: 17/807,169

(22) Filed: Jun. 16, 2022

Related U.S. Application Data
(63) Continuation-in-part of application No. 29/864,044, filed on May 6, 2022, now Pat. No. D987091.
(60) Provisional application No. 63/320,528, filed on Mar. 16, 2022.

(51) Int. Cl. F24C 7/08; H05B 1/02

(52) U.S. Cl. CPC F24C 7/088; H05B 1/0244

(57) ABSTRACT

A pot includes a hollow melting chamber with a base and a sidewall extending from the base to form an open top. The sidewall has a hole adjacent to the base and a valve mounted to the hole. The valve dispenses viscous products when it is in an open position. the base has a heating element housed in its lower surface. The heating element maintains wax in a liquid state without exceeding its smoking temperature. There is no need to pick up the hot pot to dispense wax so the risk of getting burned is reduced.

### CROSS-REFERENCE TO RELATED APPLICATION

This application claims the benefit of priority of U.S. provisional application No. 63/320,528, filed Mar. 16, 2022, the contents of which are herein incorporated by reference. This application also claims priority to U.S. design application No. 29/864,044, filed May 6, 2022, the contents of which are herein incorporated by reference.

### BACKGROUND OF THE INVENTION

The present invention relates to an apparatus for liquefying meltable material and, more particularly, to a wax melting pot.

In candle making, wax is often melted on a stove or in a pot and then poured out of the pot. Pouring hot wax can be very difficult, especially when the melting apparatus is filled all the way. The candlemaker takes the chance of pouring hot wax all over his or her body. Once the candlemaker gets a slight burn, the first instinct is to jerk fast which may cause more burns. Currently, no commercially available pot has a means of dispensing melted wax without lifting and/or tipping the pot.

As can be seen, there is a need for a device to safely melt and dispense wax for candle making.

### SUMMARY OF THE INVENTION

In one aspect of the present invention, a pot for regulated dispensation of melted wax comprises a hollow melting chamber having a base with a sidewall extending from a circumference of the base to form an open top, said sidewall having an aperture adjacent to the base; a valve threadedly mounted to the aperture, wherein the valve is configured to dispense viscous products when in an open position; and a heating element housed in a lower surface of the base, said heating element being operative to maintain a wax in a liquid state without exceeding a smoking temperature thereof.

These and other features, aspects and advantages of the present invention will become better understood with reference to the following drawings, description, and claims.

### BRIEF DESCRIPTION OF THE DRAWINGS

FIG. 1 is a perspective view of a wax melting pot according to an embodiment of the present invention;

FIG. 2 is a front elevation view thereof;

FIG. 3 is an exploded view thereof;

FIG. 4 is a top plan view thereof;

FIG. 5 is a bottom plan view thereof;

FIG. 6 is a sectional view thereof, taken along line 6-6 from FIG. 2;

FIG. 7 is a detail view thereof; and

FIG. 8 is another sectional view thereof, shown in an open condition.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a pot with a lever valve built in at the bottom of the pot to allow safe dispensing of hot wax. There is no need to pick up a hot pot so the risk of getting burned is reduced.

To use the inventive pot, insert hard wax into a melting chamber. Plug the pot into a wall outlet. Turn a control dial to a predetermined temperature. Wait until the wax has melted, i.e., the wax is in a liquid state. Then open the valve to dispense hot wax easily and safely into a pouring pitcher. It may also be used to melt other viscous products that have a sufficiently low viscosity to be dispensed through the valve.

The materials and method of manufacture are not particularly limited. For example, the pot may be formed of cast aluminum. A lid may be made primarily of glass, enabling the user to safely monitor the progress toward melting the wax without losing heat from the melting chamber. The lid may have components selected from a group consisting of: a glass surface; a knob; a vent opening; and any combination thereof.

The pot comprises a ball valve according to some embodiments of the present invention. The valve generally comprises a rubber covered handle to prevent burning the user's hands when opening the valve to dispense hot wax. The valve may have a recessed groove at the front seat so that a silicone O-ring may be slipped on. The O-ring creates a leak-proof seal so that the user may safely dispense hot wax without it leaking out of the melter. The valve may further comprise a lock nut on the back side to tighten onto the melter.

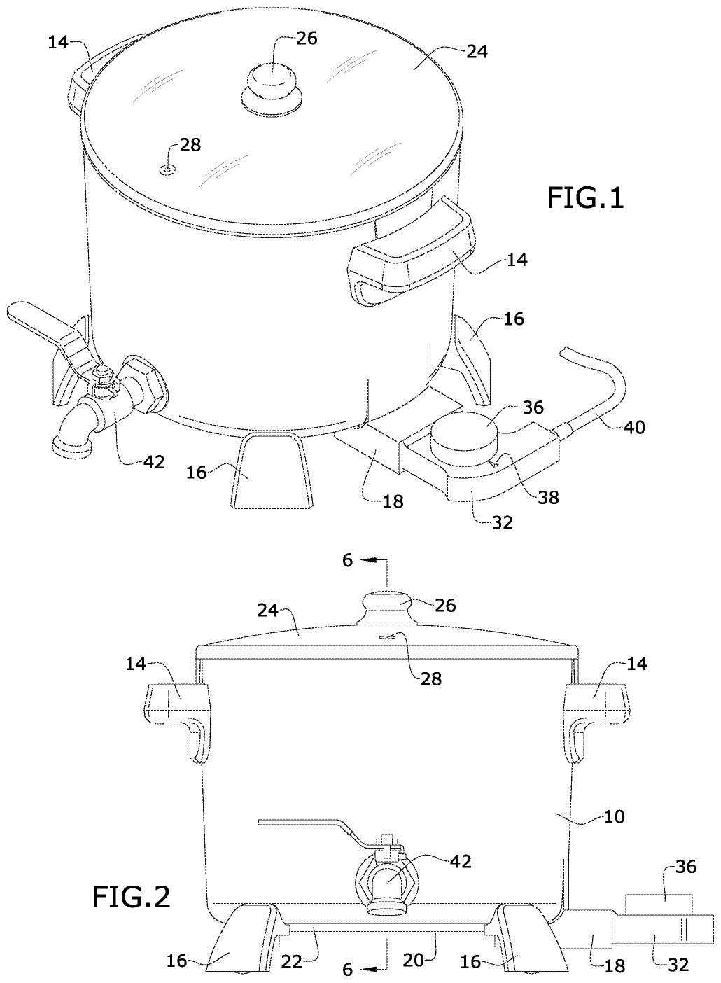

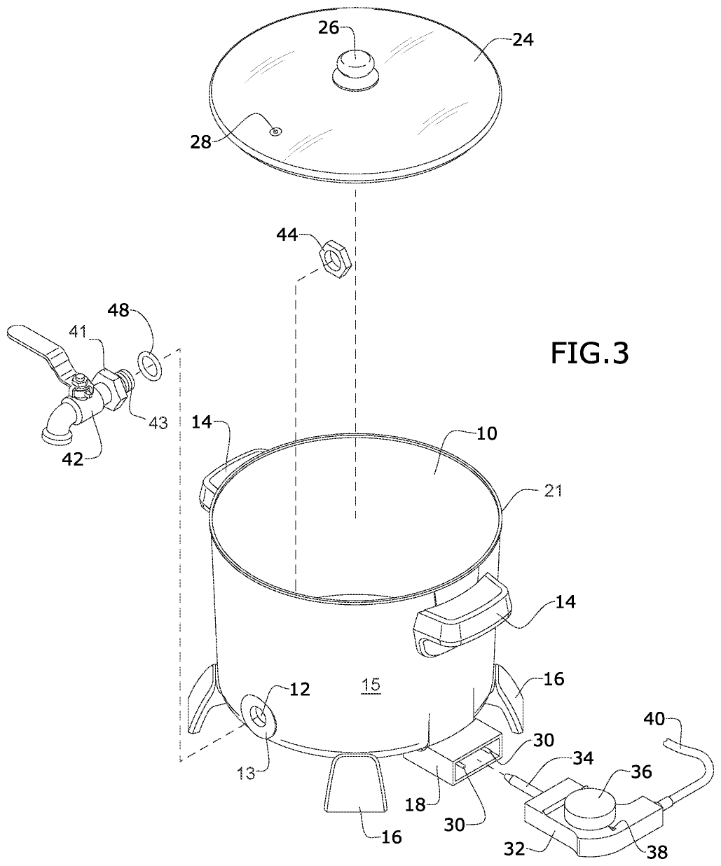

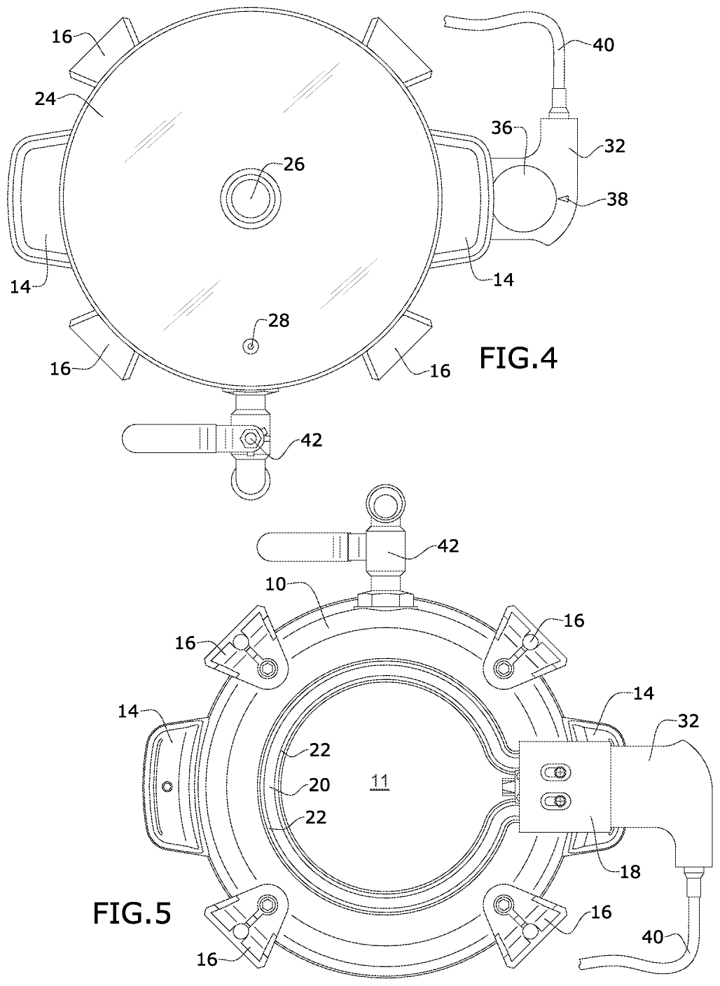

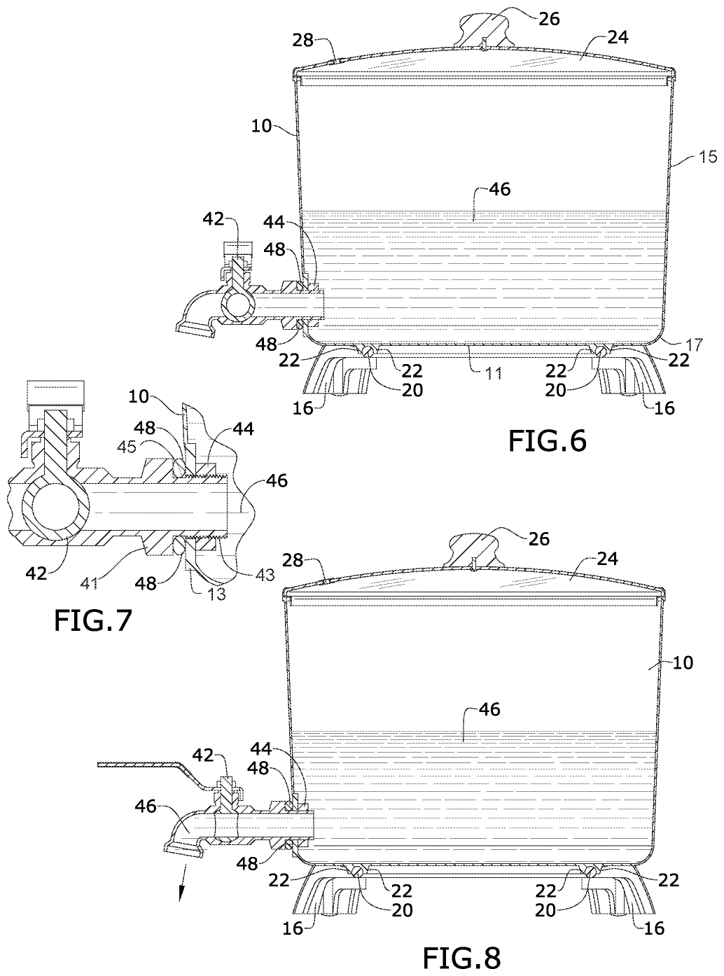

Referring to FIGS. 1 through 7, a pot 10 with a base and cylindrical sidewall forms a hollow melting chamber with an open top having a circumference of predetermined size. An opening or aperture 12 in the sidewall at a position abutting (adjoin, border on, adjacent to) the base has an easy pour valve 42 threadedly coupled to the sidewall with a nut 44. The valve 42 has a recessed region to accommodate an o-ring 48 between a threaded portion and a flange, sealing the join between the valve 42 flange and the sidewall of the pot 10. The region of the sidewall around the aperture 12 is planar to fully seat the valve. Legs or feet 16 enable a user to place the pot 10 on any suitable surface without risk of burning the supporting surface and handles 14 mounted to the sidewall at diametrically opposed positions provide a secure grip on the pot. A heating element 20 comprising an element saddle ring 22 built into the bottom of the pot 10 (i.e., the lower surface of the base) is electrically connected to a plug receptacle 18 which removably mates with a power plug 32 and is electrically connected via electrodes 30, 34. The power plug 32 has thermostat 36 with a temperature dial or control knob to regulate operating temperature, keeping the wax below its smoking temperature, a power indicator 38, and a power cord 40 for power input. The pot 10 may be covered with a lid 24 having a knob 26 and a vent opening 28. As shown in FIGS. 6 and 7, wax 46 may be raised to a melting temperature with the valve 42 in a closed position. The melted wax 46 may be dispensed through the valve 42 in an open position and regulated by turning a lever handle.

It should be understood, of course, that the foregoing relates to exemplary embodiments of the invention and that modifications may be made without departing from the spirit and scope of the invention as set forth in the following claims.

1. A pot for regulated dispensation of melted wax, comprising:
a) a hollow melting chamber having a planar base with an upwardly curved inner transition region around its circumference and a sidewall extending from the upwardly curved inner transition region to form an open top, said sidewall having an aperture adjacent to the upwardly curved transition region, said sidewall having a disk-shaped planar region encircling the aperture;
b) a valve threadedly mounted to the aperture, wherein the valve is configured to dispense viscous products when in an open position; and
c) a ring heating element housed in a groove having walls extending from a lower surface of the base, said heating element being operative to maintain a wax in a liquid state without exceeding a smoking temperature thereof.

2. The pot of claim 1, wherein the base and the sidewall are cast aluminum.

3. The pot of claim 1, further comprising feet mounted to the base, said feet being operative to elevate the base from a supporting surface.

4. The pot of claim 1, wherein the heating element further comprises a plug receptacle configured to accommodate a power plug with a cord.

5. The pot of claim 1, further comprising a thermostat electrically connected to the heating element.

6. The pot of claim 1, wherein the valve is secured to the sidewall with a nut.

7. The pot of claim 1, wherein the valve has a recessed region, configured to accommodate an O-ring, between a threaded portion and a flange.

8. The pot of claim 1, wherein the valve is a ball valve with a lever handle.

9. The pot of claim 1, further comprising handles mounted to the sidewall adjacent to the open top at diametrically opposed positions.

10. The pot of claim 1, further comprising a lid mated to the open top, wherein the lid comprises one or more components selected from the group consisting of: a glass surface; a knob; a vent opening; and any combination thereof.

11. A wax melting vessel, comprising:
a pot having a planar bottom with an upward facing first surface opposite a downward facing second surface and a sidewall surrounding said bottom and terminating at an upper rim, wherein an inner transition region between the planar bottom and the sidewall is upwardly curved, said sidewall having a disk-shaped planar region encircling an aperture formed adjacent to the inner transition region;
a ring heating element affixed to the downward facing second surface;
a ball valve assembly having a threaded portion spaced from a flange portion forming a recessed region therebetween, with an o-ring seated in the recessed region such that the o-ring directly contacts the disk-shaped planar region and the flange portion and is compressed therebetween, said ball valve assembly being mounted to the aperture and fastened with a lock nut, and said ball valve assembly being operative to dispense melted wax;
feet mounted to the planar bottom at positions equally spaced along its circumference; and
diametrically opposed handles mounted to the sidewall, wherein the aperture is horizontally and vertically spaced along the sidewall from each of the handles.

12. The wax melting vessel of claim 11, further comprising a glass lid mated to the upper rim, said glass lid having a central knob and a vent opening.
